(19) United States
(12) Patent Application Publication
(10) Pub. No.: US 2006/0066649 A1
(43) Pub. Date: Mar. 30, 2006

(54) Method and apparatus for recording images on deformed image-recordable object

(75) Inventors: Takuya Hirashima, Kanagawa-ken (JP); Takeshi Fujii, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/239,312

(22) Filed: Sep. 30, 2005

(30) Foreign Application Priority Data
Sep. 30, 2004 (JP) 287320/2004
Mar. 11, 2005 (JP) 069332/2005

(51) Int. Cl. B41J 29/38

(52) U.S. Cl. 347/5

(57) ABSTRACT

In an image-recording apparatus for recording at least two images at desired positions on an image-recordable object: positions of a plurality of reference marks which are arranged in advance on the image-recordable object and common to the at least two images are detected; each of recording positions of the at least two images is corrected on the basis of the positions of the plurality of reference marks detected in the step (a); and the at least two images are recorded on the image-recordable object in an arrangement determined by the recording positions corrected in the step (b). Each of the recording positions has a positional relationship with the plurality of reference marks.

### BACKGROUND OF THE INVENTION

1. Field of the Invention

The present invention relates to an image-recording method and an image-recording apparatus for recording (e.g., drawing, plotting, or transferring) images on an image-recordable object (e.g., a substrate) in such a manner that the images are desiredly arranged on the image-recordable object.

2. Description of the Related Art

Conventionally, various exposure systems utilizing the photolithographic technology have been proposed as systems for recording predetermined wiring patterns on a substrate of a printed wiring board (hereinafter referred to as PWB).

In one of the above exposure systems, a wiring pattern is formed by scanning a substrate (on which, for example, photoresist is applied) with a light beam in a main-scanning direction and a sub-scanning direction, and modulating the light beam on the basis of image data representing the wiring pattern.

Wiring patterns formed in a PWB by using an exposure system as above are increasingly becoming finer. For example, in the case where a multilayer PWB is formed, it is necessary to align wiring patterns in respective layers with high precision.

In order to align the wiring patterns as above, wiring patterns in each layer are formed by exposure at desired positions on a substrate in advance. However, when a multilayer PWB is formed, the substrates are heated during a pressing process for laminating the layers together, and the heat deforms the substrates in some cases. Therefore, in the case where the wiring patterns in each layer are formed by exposure at desired positions on a substrate in advance, misalignment can occur between the wiring patterns formed in the different layers, i.e., it can become difficult to achieve high-precision position alignment between the wiring patterns formed in the different layers.

In an exposure system which has been proposed for solving the above problem, holes are formed near the four corners of a substrate in each layer on the basis of information on the positions of reference marks, which are preset. In the exposing process, the holes are detected, the amount of deformation is obtained on the basis of the above information on the positions of the reference marks and information on the positions at which the holes are detected, and the positions of the wiring patterns are corrected according to the amount of deformation, so that high-precision position alignment is achieved without influence of the deformation of the substrate.

Incidentally, demands for PWBs having relatively small size are increasing with the widely spreading use of small-sized electronic devices such as mobile telephone. In the case where small-sized PWBs as above are manufactured, exposure is performed so that a great number of small-sized wiring patterns are arranged on a single, large substrate.

However, in the case where a great number of wiring patterns are exposed on a single substrate in such a manner that the entire image including the great number of small-sized wiring patterns are corrected on the basis of the four holes formed near the four corners, there is a possibility that the respective wiring patterns cannot be aligned with high precision, since the substrate is not uniformly deformed.

For example, in a method disclosed in Japanese Unexamined Patent Publication No. 2000-122303, holes corresponding to the respective wiring patterns are provided in addition to the four holes near the four corners of the substrate, and the positions at which the respective wiring patterns are drawn are corrected according to the amounts of movement of the holes corresponding to the respective wiring patterns caused by the deformation. However, very bothersome processes are necessary for providing the holes corresponding to the respective wiring patterns as disclosed in Japanese Unexamined Patent Publication No. 2000-122303, and the manufacturing cost increases. Further, since it is necessary to prepare substrates in which holes are arranged at different positions according to the sizes, shapes, and arrangement of the respective wiring patterns, the manufacturing efficiency is not satisfactory.

### SUMMARY OF THE INVENTION

The present invention has been developed in view of the above circumstances.

The object of the present invention is to provide an image-recording method and an image-recording apparatus which can realize high-precision position alignment of individual wiring patterns without influence of deformation of a substrate.

(I) In order to accomplish the above object, according to the first aspect of the present invention, there is provided an image-recording method for recording at least two images at desired positions on an image-recordable object is provided. The image-recording method comprises the steps of: (a) detecting positions of a plurality of reference marks which are arranged in advance on the image-recordable object and common to the at least two images; (b) correcting each of recording positions of the at least two images on the basis of the positions of the plurality of reference marks detected in the step (a), where each of the recording positions has a positional relationship with the plurality of reference marks; and (c) recording the at least two images on the image-recordable object in an arrangement determined by the recording positions corrected in the step (b).

In order to accomplish the aforementioned object, according to the second aspect of the present invention, there is provided an image-recording method for recording at least two images at desired positions on an image-recordable object is provided. The image-recording method comprises the steps of: (a) detecting positions of a plurality of reference marks which are arranged in advance on the image-recordable object; (b) correcting each of recording positions of the at least two images on the basis of the positions of the plurality of reference marks detected in the step (a), where the recording positions are determined so that the at least two images are located in a region determined by the plurality of reference marks; and (c) recording the at least two images on the image-recordable object in an arrangement determined by the recording positions corrected in the step (b).

In the image-recording method according to the second aspect of the present invention, the meaning of the expression “the at least two images are located in a region determined by the plurality of reference marks” includes the case in which the at least two images are entirely contained within the region determined by the plurality of reference marks, and the case in which at least a portion of each of the at least two images is contained within the region.

In order to accomplish the aforementioned object, according to the third aspect of the present invention, there is provided an image-recording method for recording at least two images at desired positions on an image-recordable object is provided. The image-recording method comprises the steps of: (a) detecting positions of a plurality of reference marks which are arranged in advance on the image-recordable object and common to the at least two images; (b) correcting each of recording positions of the at least two images on the basis of the positions of the plurality of reference marks detected in the step (a), where each of the recording positions has a positional relationship with at least one of the plurality of reference marks corresponding to the image; and (c) recording the at least two images on the image-recordable object in an arrangement determined by the recording positions corrected in the step (b).

In order to accomplish the aforementioned object, according to the fourth aspect of the present invention, there is provided an image-recording method for recording at least one image at at least one desired position on an image-recordable object is provided. The image-recording method comprises the steps of: (a) detecting positions of a plurality of reference marks which are arranged in advance on the image-recordable object and common to the at least one image; (b) correcting at least two recording positions for the at least one image on the basis of the positions of the plurality of reference marks detected in the step (a), where each of the at least two recording positions has a positional relationship with the plurality of reference marks; and (c) recording the at least one image on the image-recordable object so that the arrangement, including at least one of the inclination and the size, of each of the at least one image is corrected in accordance with the at least two recording positions corrected in the step (b).

Preferably, in the step (b) in the image-recording method according to the fourth aspect of the present invention, the positional relationship with the plurality of reference marks is set for each of the at least one image.

When each of the image-recording methods according to the first to fourth aspects of the present invention is used, it is possible to realize highly precise image recording, and increase the manufacturing efficiency. In particular, when each of the image-recording methods according to the first to fourth aspects of the present invention is used, it is possible to realize highly precise position alignment in consideration of the inclination and size of each image without influence of deformation of the image-recordable object.

In the step (b) in each of the image-recording methods according to the first to fourth aspects of the present invention, the recording positions may be corrected in any manner in which the positional relationship between the positions of the plurality of reference marks detected in the step (a) and predetermined positions of the reference marks.

In addition, preferably, each of the image-recording methods according to the first, second and fourth aspects of the present invention may also have one or any possible combination of the following additional features (i) to (iv).
(i) In the step (b), the recording positions are individually corrected on the basis of deviations of the positions of the plurality of reference marks detected in the step (a), from the predetermined positions of the reference marks.
(ii) In the step (b), the recording positions are individually corrected on the basis of the positions of the plurality of reference marks detected in the step (a) and the positional relationship between each recording position and the plurality of reference marks.
(iii) In each of the image-recording methods according to the first, second and fourth aspects of the present invention having the above feature (ii), the positional relationship is expressed as a function. In this case, the recording positions may be corrected, for example, by substituting the positions of the plurality of reference marks detected in the step (a), into the function. Alternatively, it is possible to correct the function per se on the basis of the deviations of the positions of the plurality of reference marks detected in the step (a), from the predetermined positions of the reference marks, and obtain the corrected recording positions on the basis of the corrected function and the predetermined positions of the reference marks.
(iv) The step (c) comprises the substeps of: (c1) generating corrected image data by correcting image data representing an entire image which includes the at least one or two images and is to be recorded in a predetermined region on the image-recordable object, on the basis of the recording positions corrected in the step (b); and (c2) recording the entire image including the at least one or two images on the predetermined region on the basis of the corrected image data.

(II) In order to accomplish the aforementioned object, according to the fifth aspect of the present invention, there is provided an image-recording apparatus for recording at least two images at desired positions on an image-recordable object is provided. The image-recording apparatus comprises: a detection unit which detects positions of a plurality of reference marks arranged in advance on the image-recordable object and common to the at least two images; a correction unit which individually corrects recording positions of the at least two images on the basis of the positions of the plurality of reference marks detected by the detection unit, where each of the recording positions has a positional relationship with the plurality of reference marks; and a recording unit which records the at least two images on the image-recordable object in an arrangement determined by the recording positions corrected by the correction unit. The image-recording apparatus according to the fifth aspect of the present invention executes the image-recording method according to the first aspect of the present invention.

In order to accomplish the aforementioned object, according to the sixth aspect of the present invention, there is provided an image-recording apparatus for recording at least two images at desired positions on an image-recordable object is provided. The image-recording apparatus comprises: a detection unit which detects positions of a plurality of reference marks arranged in advance on the image-recordable object; a correction unit which individually corrects recording positions of the at least two images on the basis of the positions of the plurality of reference marks detected by the detection unit, where the recording positions are determined so that the at least two images are located in a region determined by the plurality of reference marks; and a recording unit which records the at least two images on the image-recordable object in an arrangement determined by the recording positions corrected by the correction unit. The image-recording apparatus according to the sixth aspect of the present invention executes the image-recording method according to the second aspect of the present invention.

In order to accomplish the aforementioned object, according to the seventh aspect of the present invention, there is provided an image-recording apparatus for recording at least two images at desired positions on an image-recordable object is provided. The image-recording apparatus comprises: a detection unit which detects positions of a plurality of reference marks arranged in advance on the image-recordable object and common to the at least two images; a correction unit which individually corrects recording positions of the at least two images on the basis of the positions of the plurality of reference marks detected by the detection unit, where each of the recording positions has a positional relationship with at least one of the plurality of reference marks corresponding to the image; and a recording unit which records the at least two images on the image-recordable object in an arrangement determined by the recording positions corrected by the correction unit. The image-recording apparatus according to the seventh aspect of the present invention executes the image-recording method according to the third aspect of the present invention.

In order to accomplish the aforementioned object, according to the eighth aspect of the present invention, there is provided an image-recording apparatus for recording at least one image at at least one desired position on an image-recordable object is provided. The image-recording apparatus comprises: a detection unit which detects positions of a plurality of reference marks arranged in advance on the image-recordable object and common to the at least one image; a correction unit which corrects at least two recording positions for the at least one image on the basis of the positions of the plurality of reference marks detected by the detection unit, where each of the at least two recording positions has a positional relationship with the plurality of reference marks; and a recording unit which records the at least one image on the image-recordable object so that the arrangement, including at least one of the inclination and the size, of each of the at least one image is corrected in accordance with the at least two recording positions corrected by the correction unit. The image-recording apparatus according to the eighth aspect of the present invention executes the image-recording method according to the fourth aspect of the present invention.

Preferably, in the image-recording apparatus according to the eighth aspect of the present invention, the positional relationship with the plurality of reference marks is set for each of the at least one image.

In addition, preferably, each of the image-recording apparatuses according to the fifth, sixth, and eighth aspects of the present invention may also have one or any possible combination of the following additional features (v) to (viii).
(v) Each of the recording positions is corrected by the correction unit on the basis of deviations of the positions of the plurality of reference marks detected by the detection unit, from the predetermined positions of the reference marks.
(vi) Each of the recording positions is corrected by the correction unit on the basis of the positions of the plurality of reference marks detected by the detection unit and the positional relationship.
(vii) In the image-recording method according to the sixth aspect of the present invention having the above feature (vi), the positional relationship is expressed as a function.
(viii) Each of the image-recording apparatuses according to the fifth, sixth and eighth aspects of the present invention further comprises an image-data correction unit which generates corrected image data by correcting image data representing an entire image to be recorded in a predetermined region on the image-recordable object, where the entire image includes the at least one or two images, and the recording unit records the at least one or two images on the basis of the corrected image data.

(III) In order to accomplish the aforementioned object, according to the ninth aspect of the present invention, there is provided an image-recording method for recording at least one image at at least one desired position on an image-recordable object is provided. The image-recording method comprises the steps of: (a) detecting positions of a plurality of reference marks which are arranged in advance on the image-recordable object and common to the at least one image; (b) correcting at least two arrangement-determination positions for each of the at least one image on the basis of the positions of the plurality of reference marks detected in the step (a), where each of the at least two arrangement-determination positions has a positional relationship with the plurality of reference marks, and the at least two arrangement-determination positions for each of the at least one image determine an arrangement, including a inclination, and size, of the image; and (c) recording the at least one image on the image-recordable object in the arrangement determined by the at least two arrangement-determination positions corrected in the step (b).

(IV) In order to accomplish the aforementioned object, according to the tenth aspect of the present invention, there is provided an image-recording apparatus for recording at least one image at at least one desired position on an image-recordable object is provided. The image-recording method comprises: a detection unit which detects positions of a plurality of reference marks arranged in advance on the image-recordable object and common to the at least one image; a correction unit which corrects at least two arrangement-determination positions for each of the at least one image on the basis of the positions of the plurality of reference marks detected by the detection unit, where each of the at least two arrangement-determination positions has a positional relationship with the plurality of reference marks, and at least two arrangement-determination positions for each of the at least one image determine an arrangement, including a inclination, and size, of the image; and a recording unit which records the at least one image on the image-recordable object in such a manner that the at least two images are respectively arranged in accordance with the at least two arrangement-determination positions corrected by the correction unit.

### DESCRIPTION OF THE DRAWINGS

FIG. 1 is a schematic perspective view of an exposure system according to an embodiment of the present invention.

FIG. 2 is a schematic perspective view of a scanner in the exposure system of FIG. 1.

FIG. 3A is a plan view of a substrate, and indicates exposed areas on an exposure surface of the substrate.

FIG. 3B is a diagram illustrating an arrangement of exposure areas produced by a plurality of exposure heads.

FIG. 4 is a schematic plan view of one of the exposure heads containing a digital micromirror device (DMD) in the exposure system of FIG. 1.

FIG. 5 is a diagram illustrating an electric control system for electrically controlling the exposure system of FIG. 1.

FIG. 6 is a diagram schematically illustrating a first exemplary arrangement of reference marks and wiring patterns on a substrate before deformation, and arrangement-determination positions for the wiring patterns before correction.

FIG. 7 is a diagram presented for explaining a first exemplary method for correcting an arrangement-determination position.

FIG. 8 is a diagram schematically illustrating examples of arrangement of the reference marks and the wiring patterns on the substrate of FIG. 6 after deformation, and the arrangement-determination positions for the wiring patterns after correction.

FIG. 9 is a diagram schematically illustrating a second exemplary arrangement of reference marks and wiring patterns on a substrate before deformation, and arrangement-determination positions for the wiring patterns before correction.

FIG. 10 is a diagram schematically illustrating a third exemplary arrangement of reference marks and wiring patterns on a substrate before deformation, and arrangement-determination positions for the wiring patterns before correction.

FIG. 11 is a diagram presented for explaining a second exemplary method for correcting an arrangement-determination position.

FIG. 12 is a diagram schematically illustrating a fourth exemplary arrangement of reference marks and wiring patterns on a substrate before deformation, and arrangement-determination positions for the wiring patterns before correction.

FIG. 13 is a diagram schematically illustrating a fifth exemplary arrangement of reference marks and wiring patterns on a substrate before deformation, and arrangement-determination positions for the wiring patterns before correction.

FIG. 14 is a diagram presented for explaining a third exemplary method for correcting the recording-position information.

### DESCRIPTION OF PREFERRED EMBODIMENTS

An embodiment of the present invention is explained in detail below with reference to drawings.

FIG. 1 is a schematic perspective view of an exposure system according to an embodiment of the present invention. The exposure system 10 of FIG. 1 exposes a plurality of wiring patterns on a substrate, and can expose wiring patterns on each layer of a multilayer substrate such as a multilayer printed wiring board (PWB), as well as on a single-layer substrate. Further, the substrate may be any type of structural substance (e.g., a filter for a display device or a semiconductor device). The construction of the exposure system 10 is briefly explained below.

As illustrated in FIG. 1, the exposure system 10 comprises a movable, planar stage 14, which holds a substrate 12 on its surface by suction. Two guides 20 extending in a direction along which the stage moves are arranged on an upper surface of a mount table 18, which is formed of a thick plate supported by four legs 16. The stage 14 is supported by the guides 20 so that the length direction of the stage 14 corresponds to the direction along which the stage 14 moves, and the stage 14 can move in either direction along the guides 20.

A U-shaped gate 22 is arranged at the center of the mount table 18 so as to straddle the movement path of the stage 14. Two ends of the U-shaped gate 22 are respectively fixed to side surfaces of the mount table 18. A scanner 24 is arranged on one side of the U-shaped gate 22, and a plurality of cameras 26 (three cameras in this example) are arranged on the other side of the U-shaped gate 22, so that the scanner 24 and the cameras 26 are fixedly located above the path of the stage 14. A plurality (six in this example) of round reference marks 12a are arranged on the substrate 12 in advance. The plurality of cameras 26 are provided for detecting the front and rear edges of and the reference marks 12a on the substrate 12. The reference marks 12a on the substrate 12 are, for example, holes formed on the substrate 12 in accordance with reference-mark-position information, which is preset. Alternatively, the reference marks may be realized by lands, vias, or etching marks. Further, it is possible to use as the reference marks 12a predetermined patterns (e.g., portions of circuit patterns) exposed on the substrate 12. Details of the reference marks 12a and the reference-mark-position information are explained later. The scanner 24 and the cameras 26 are fixed to the U-shaped gate 22 so as to be fixedly located above the path of the stage 14, and connected to a controller (not shown) which controls the scanner 24 and the cameras 26.

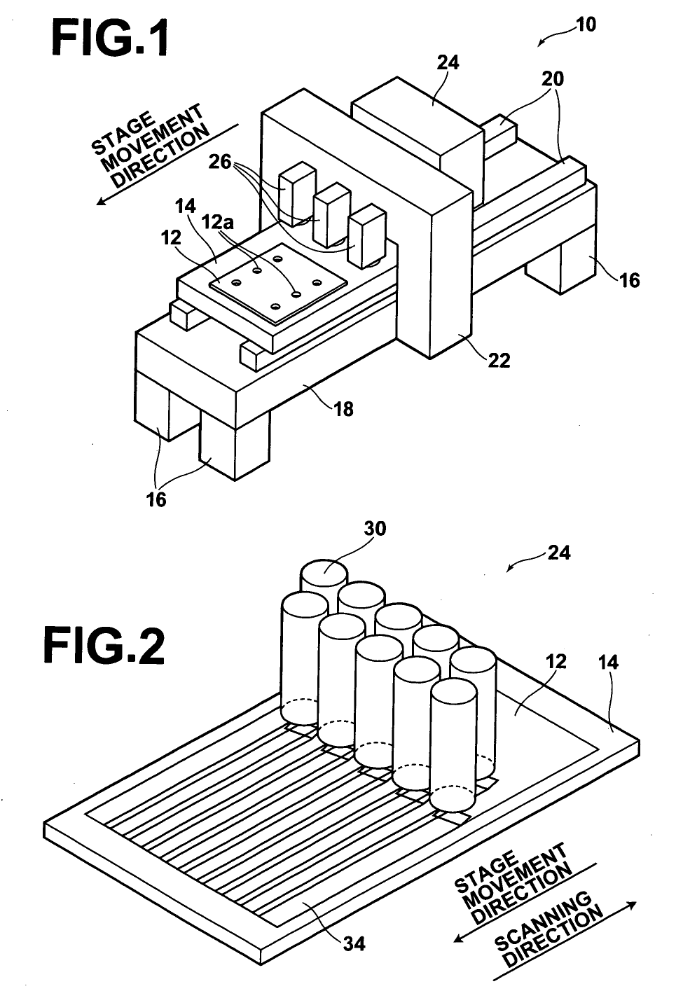

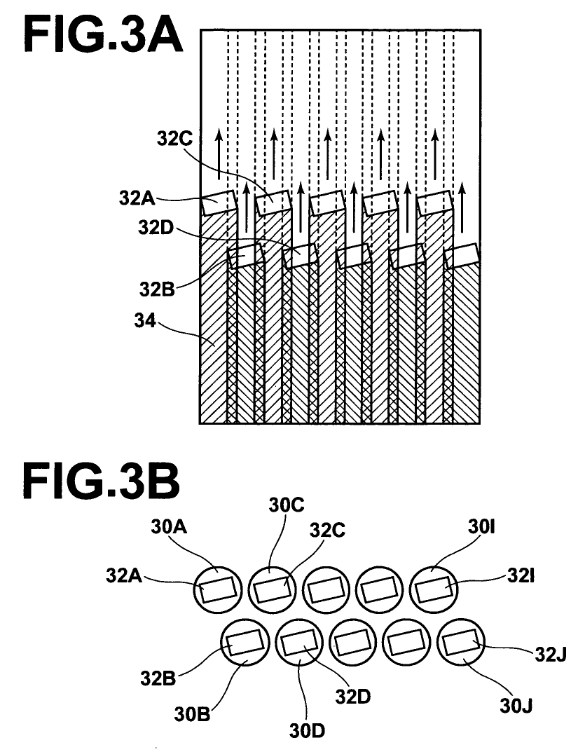

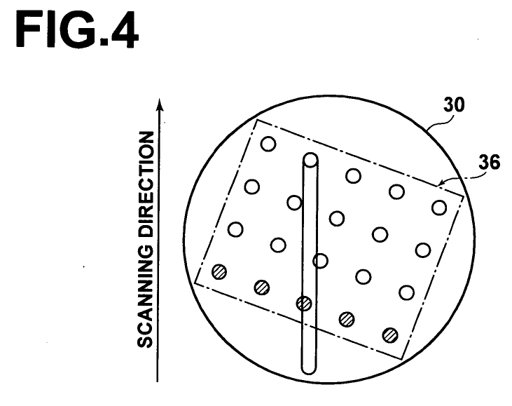

FIG. 2 is a schematic perspective view of the scanner in the exposure system of FIG. 1, FIG. 3A is a plan view of a substrate, and indicates exposed areas on an exposure surface of the substrate, FIG. 3B is a diagram illustrating an arrangement of exposure areas produced by a plurality of exposure heads, and FIG. 4 is a schematic plan view of one of the exposure heads containing a digital micromirror device (DMD) in the exposure system of FIG. 1.

As illustrated in FIGS. 2 and 3B, the scanner 24 comprises a plurality of exposure heads 30 (e.g., ten exposure heads 30A to 30J) which are arranged nearly in a matrix with two rows and five columns.

As illustrated in FIG. 4, each of the exposure heads 30A through 30J comprises a digital micromirror device (DMD) 36 as a spatial light-modulation device (SLM), which spatially modulates a light beam incident on the DMD 36. The DMD 36 is arranged in such a manner that the direction along which the pixels are arranged makes a predetermined inclination angle θ with the scanning direction, which is preset. Therefore, exposure areas 32A to 32J (hereinafter collectively referred to exposure areas 32) exposed with the respective exposure heads 30A to 30J has a rectangular shape inclined from the scanning direction. Thus, when the stage 14 moves, bandlike exposed areas 34 are formed on the substrate 12 in correspondence with the exposure heads 30, respectively. Further, it is possible to use any other type of spatial light-modulation device (SLM) instead of the DMD.

The DMD 36 in each of the exposure heads 30 is constituted by a plurality of micromirrors being two-dimensionally arrayed and respectively corresponding to pixels, and the DMD 36 is on-off controlled on a pixel-by-pixel basis, so that a dot pattern (black-and-white pattern) corresponding to the on-off states of the micromirrors is exposed on the substrate 12. As illustrated in FIG. 4, the aforementioned bandlike exposed areas 34 are formed with dots which are two-dimensionally arrayed.

The dot pattern formed with the two-dimensionally arrayed dots are inclined from the scanning direction, dots arrayed in a line in the scanning direction pass through the gaps between dots arrayed in a line in a direction intersecting with the scanning direction, and therefore it is possible to achieve high resolution.

Depending on the variations in adjustment of the inclination angle, a portion of the dots which can be exposed with each exposure head is not used. For example, in the example illustrated in FIG. 4, the dots indicated by the hatched circles are not used, and therefore the micromirrors in the DMD 36 corresponding to these dots are maintained in the off state at all times.

In addition, as illustrated in FIGS. 3A and 3B, exposure heads linearly arrayed in each row are shifted by a predetermined amount in the direction in which the exposure heads in each row are arrayed, from exposure heads linearly arrayed in an adjacent row so that each of the bandlike exposed areas 34 partially overlaps an adjacent one of the exposed area 34. The predetermined amount is an integer multiple of the longer side of each of the rectangular exposure area 32. In this example, the integer is one. For example, although the area under the gap between the leftmost exposure area 32A and the second exposure area 32C in the first row, which is not exposed with the exposure areas 32A, 32C, . . . 32I in the first row, can be exposed with the leftmost exposure area 32B in the second row. Similarly, the area under the gap between the leftmost exposure area 32B and the second exposure area 32D in the first row, which cannot be exposed with the exposure areas 32B, 32D, . . . 32J in the second row, can be exposed with the second exposure area 32C in the first row.

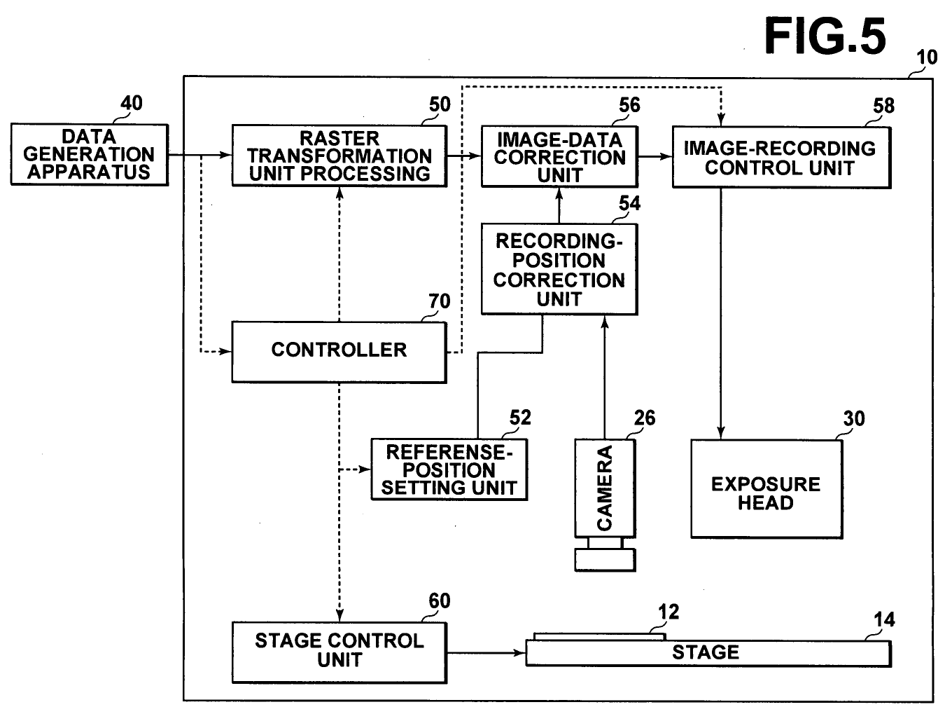

Next, the electric control system in the exposure system 10 according to the present embodiment is explained below. FIG. 5 is a diagram illustrating the electric control system for electrically controlling the exposure system of FIG. 1. As illustrated in FIG. 5, the electric control system in the exposure system 10 comprises a raster-transformation processing unit 50, a reference-position setting unit 52, a recording-position correction unit 54, an image-data correction unit 56, an image-recording control unit 58, a stage control unit 60, and a controller 70.

The raster-transformation processing unit 50 receives vector data representing wiring patterns to be exposed, and converts the vector data into raster data (in bit-map form), where the vector data are outputted from a data generation apparatus 40, which comprises a CAM (computer aided manufacturing) station. In the reference-position setting unit 52, reference-mark-position information and recording-position information for a plurality of wiring patterns are set. The recording-position correction unit 54 corrects the recording-position information on the basis of the reference-mark-position information and detected-mark information which indicates the positions of the reference marks 12a detected by the cameras 26. The image-data correction unit 56 corrects the raster data representing the wiring patterns on the basis of the recording-position information corrected by the recording-position correction unit 54, and generates corrected image data. The image-recording control unit 58 controls the exposure heads 30 so that the exposure is performed based on the corrected image data by using the exposure heads 30. The stage control unit 60 controls the movement of the stage 14 in the stage movement direction. The controller 70 controls the entire exposure system 10. Details of the reference-mark-position information, the recording-position information, and methods for correcting the recording-position information are explained later.

The operations of the exposure system 10 are explained below with reference to FIG. 5.

First, the data generation apparatus 40 generates vector data representing the entire image pattern containing a plurality of wiring patterns to be exposed on the substrate 12. The generated vector data are inputted into the raster-transformation processing unit 50. The raster-transformation processing unit 50 converts the vector data into the raster data, and inputs the raster data into the image-data correction unit 56. The image-data correction unit 56 temporarily stores the inputted raster data.

In addition, when the vector data are inputted into the reference-position setting unit 52 as above, the controller 70, which controls the operations of the entire exposure system 10, outputs to the stage control unit 60 an instruction signal. The stage control unit 60 outputs a control signal to a stage driving device (not shown) according to the instruction signal. In response to the control signal, the stage driving device once moves the (movable) stage 14 along the guides 20 from the position illustrated in FIG. 1 to a predetermined initial position on the upstream side, and thereafter moves the stage 14 at a desired speed in the stage movement direction.

When the substrate 12 placed on the stage 14 and moved as above passes under the cameras 26, the cameras 26 take images of the substrate 12, and image data representing the images are inputted into the recording-position correction unit 54. The recording-position correction unit 54 detects the positions of the reference marks 12a on the substrate 12 placed on the stage 14, on the basis of the image data, and obtains the detected-mark information. The positions of the reference marks 12a can be detected, for example, by extracting round images. Alternatively, it is possible to detect the positions of the reference marks 12a by any other known methods. Specifically, the detected-mark information for the reference marks 12a can be expressed by coordinate values. In this case, for example, the origin of the coordinate system may be defined as the position of one of the four corners of the substrate 12 in the images taken by the cameras 26, or a predetermined position in the images taken by the cameras 26, or the position of one of the reference marks 12a. However, it is necessary to make the origin defined as above coincide with the origin of the coordinate system used in the reference-mark-position information.

In the reference-position setting unit 52, reference-mark-position information indicating the positions of the reference marks 12a on a standard model of the substrate 12 which has not yet undergone a pressing process is set in advance. The reference-mark-position information indicates design values, which are predetermined when the reference marks 12a are arranged on the substrate 12. The reference-mark-position information may be set by a user, or obtained and set on the basis of images of a standard model of the substrate 12 taken by the cameras 26. As mentioned before, the reference-mark-position information is set by using coordinate values.

In addition, in the reference-position setting unit 52, recording-position information indicating recording positions of or arrangement-determination positions for a plurality of wiring patterns is also set in advance, where positions at which the images (wiring patterns) are to be recorded are indicated by the recording positions, and for example, the arrangement (including the location, inclination, and size) in which each image (wiring pattern) is to be recorded can be determined by at least two of the arrangement-determination positions.

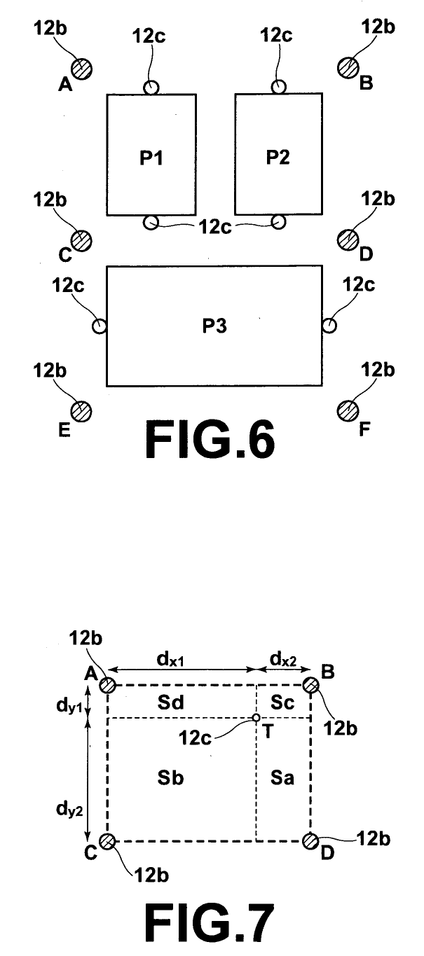

FIG. 6 is a diagram schematically illustrating a first exemplary arrangement of wiring patterns and reference marks 12a on the substrate before deformation, and the arrangement-determination positions for the wiring patterns before correction. In FIG. 6, the positions 12b of the reference marks 12a (indicated by the reference-mark-position information) are indicated by hatched circles, the arrangement-determination positions 12c indicated by the recording-position information are indicated by blank circles, and the wiring patterns P1, P2, and P3, which are actually exposed on the substrate 12, are indicated by rectangles. Although the positions of the reference marks 12a and the arrangement-determination positions 12c are indicated on the same plane in FIGS. 6 to 14, actually no marks corresponding to the recording-position information are provided on the substrate 12. In addition, although the shapes and sizes of the wiring patterns P1 and P2 are identical in the example of FIG. 6, the wiring patterns P1 and P2 may have different shapes and sizes.

The recording-position information is also set by using coordinate values, and the origin of the coordinate system used in the recording-position information is identical to the origin of the coordinate systems used in the detected-mark information and the reference-mark-position information. The recording-position information is arbitrarily set by the user according to the arrangement of the plurality of wiring patterns on the substrate 12.

In the example of FIG. 6, the recording-position information indicates, as the arrangement-determination positions, points on the center line of each rectangle parallel to the longer side of the rectangle which are located immediately outside of the rectangle. Alternatively, the recording-position information may be set in different ways.

The coordinate values set as explained above as the reference-mark-position information and the recording-position information are outputted from the reference-position setting unit 52 to the recording-position correction unit 54.

The recording-position correction unit 54 corrects the recording-position information on the basis of deviations of the positions of the reference marks 12a on the substrate 12 in the images actually taken by the cameras 26, from the positions 12b of the reference marks 12a indicated by the reference-mark-position information, where the positions of the reference marks 12a on the substrate 12 in the images actually taken by the cameras 26 are indicated as the detected-mark information, and the positions 12b of the reference marks 12a indicated by the reference-mark-position information are outputted from the reference-position setting unit 52. A method of correcting an example of an arrangement-determination position 12c indicated by the recording-position information is explained below with reference to FIG. 7, where the upper right one of the arrangement-determination positions 12c illustrated in FIG. 6 is taken as an example, and indicated by the reference T.

First, the recording-position correction unit 54 obtains the areas Sa, Sb, Sc, and Sd of the four divided regions as illustrated in FIG. 7 on the basis of the coordinate values of the arrangement-determination position T indicated by the recording-position information and the coordinate values of the four reference marks A, B, C, and D surrounding the arrangement-determination position T. Then, the recording-position correction unit 54 calculates the coordinate values (x_{T}, y_{T}) of the corrected arrangement-determination position T by substituting the coordinate values (x_{A}, y_{A}), (x_{B}, y_{B}), (x_{c}, y_{c}), and (x_{D}, y_{D}) of the four reference marks A, B, C, and D indicated by the detected-mark information, into the equation,

$$( \begin{matrix}{x}_{T} \\ {y}_{T}\end{matrix} ) = \frac{( Sa ( \begin{matrix}{x}_{A} \\ {y}_{A}\end{matrix} ) + Sb ( \begin{matrix}{x}_{B} \\ {y}_{B}\end{matrix} ) + Sc ( \begin{matrix}{x}_{c} \\ {y}_{c}\end{matrix} ) + Sd ( \begin{matrix}{x}_{D} \\ {y}_{D}\end{matrix} ) )}{( Sa + Sb + Sc + Sd )} , \qquad ( 1 )$$

where Sa=dₓ₂×d_{y2}, Sb=dₓ₁×d_{y2}, Sc=dₓ₂×d_{y1}, and Sd=dₓ₁×d_{y1}.

Similar calculation is performed for each of the other arrangement-determination positions 12c so as to obtain corrected coordinate values of the other arrangement-determination positions 12c. In this case, it is preferable that recording-position information for the wiring patterns P1 and P2 (i.e., the arrangement-determination positions 12c for the wiring patterns P1 and P2) be corrected on the basis of the reference-mark-position information and the detected-mark information for the reference marks A, B, C, and D surrounding the wiring patterns P1 and P2, and the recording-position information for the wiring pattern P3 (i.e., the arrangement-determination position 12c for the wiring pattern P3) be corrected on the basis of the reference-mark-position information and the detected-mark information for the reference marks C, D, E, and F surrounding the wiring patterns P3.

That is, the coordinate values of the corrected arrangement-determination position (e.g., the arrangement-determination position T) can be obtained by presetting a function indicating a positional relationship between the arrangement-determination position T before correction and the predetermined positions of the reference marks, and using the function. Alternatively, it is possible to obtain the coordinate values of the corrected arrangement-determination position T by obtaining the deviations of the detected positions of the plurality of reference marks (indicated by the detected-mark information) from the predetermined positions of the reference marks (indicated by the reference-mark-position information), and correcting the arrangement-determination position by use of the deviations. In this case, for example, it is possible to appropriately weight each of the deviations, and shift the arrangement-determination position by the weighted deviations.

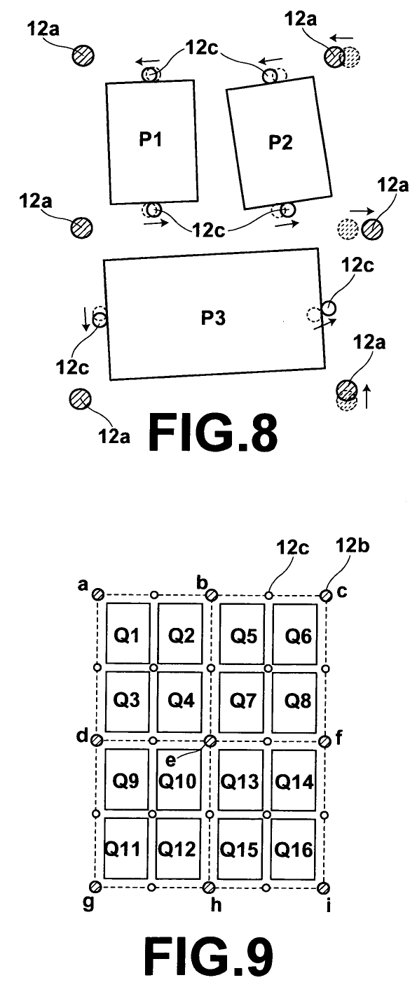

FIG. 8 is a diagram schematically illustrating examples of arrangement of the reference marks and the wiring patterns on the substrate of FIG. 6 after deformation, and the arrangement-determination positions for the wiring patterns after correction. In FIG. 8, the corrected arrangement-determination positions 12c are indicated by blank circles (drawn with solid lines), and the positions of the reference marks 12a on the deformed substrate 12 are indicated by hatched circles (hatched circles drawn with solid lines). In addition, in FIG. 8, the positions of the reference marks on the substrate before the deformation (as illustrated in FIG. 6) are indicated by dashed, hatched circles (hatched circles drawn with dashed lines), and the arrangement-determination positions before the correction are indicated by dashed circles (blank circles drawn with dashed lines).

As illustrated in FIG. 8, each of the arrangement-determination positions 12c (indicated by the recording-position information) is individually corrected according to the displacement of the reference marks 12a, so that the arrangements of the respective wiring patterns are individually corrected according to the corrected arrangement-determination positions 12c. Specifically, the recording-position information corrected as above is outputted to the image-data correction unit 56, and the image-data correction unit 56 corrects the aforementioned raster data (which are temporarily stored in advance) by processing such as rotation, shifting, and power variation (expansion or contraction) of the raster data. In FIG. 8, realization of rotation and shifting by correction of the arrangement-determination positions clearly indicated. Although expansion or contraction of each wiring pattern is not clearly indicated in FIG. 8, it is possible to correct the size of each wiring pattern by performing power variation processing on the basis of the corrected arrangement-determination positions. Further, deformation of each wiring pattern can also be corrected by expansion or contraction.

While the corrected raster data are calculated as above, the stage 14 is moved from the position illustrated in FIG. 1 to the upstream side at a desired speed.

When the front edge of the substrate 12 is detected by the cameras 26, exposure is started. Specifically, the corrected raster data calculated as above are inputted into the image-recording control unit 58, the image-recording control unit 58 outputs a control signal to each of the exposure heads 30 of the scanner 24 on the basis of the corrected raster data inputted into the image-recording control unit 58. Each of the exposure heads 30 on-off controls the respective micromirrors of the DMD 36 on the basis of the control signal so that the wiring patterns corresponding to the corrected raster data are exposed on the substrate 12.

As the stage 14 moves, the control signals are successively outputted to the exposure heads 30 so that the respective portions of the wiring patterns are successively exposed on the substrate 12. When the rear edge of the substrate 12 is detected by the cameras 26, the exposure is completed.

Although the recording-position information is preset in the above embodiment, it is unnecessary to preset the recording-position information. For example, it is possible to preset only a function indicating a relationship between the positions of the reference marks 12a and the arrangement-determination positions 12c for the wiring patterns, and calculate the corrected arrangement-determination positions by substituting the detected positions of the reference marks 12a into the function. In the example illustrated in FIG. 7, the above function may indicate or may be based on the ratios among the areas Sa, Sb, Sc, and Sd.

It is possible to directly obtain arrangement-determination positions 12c which are substantially corrected, on the basis of the positional relationships between the positions 12b of the reference marks 12a indicated by the reference-mark-position information and the arrangement-determination positions 12c indicated by the recording-position information. For example, in the manufacturing process of a multilayer circuit board, it is possible to determine the arrangement-determination positions 12c in each layer on the basis of an arrangement of wiring patterns in a lower layer or layers, or on the basis of displacement between substrates.

Alternatively, the above function may be based on the distances between the positions 12b of the reference marks indicated by the reference-mark-position information and the arrangement-determination positions 12c indicated by the recording-position information. Further, it is possible to preset a function indicating a relationship between the positions 12b indicated by the reference-mark-position information and the arrangement-determination positions 12c indicated by the recording-position information, correct the function per se on the basis of the detected-mark information, and calculate the corrected arrangement-determination positions by substituting the positions 12b of the reference marks 12a into the corrected function.

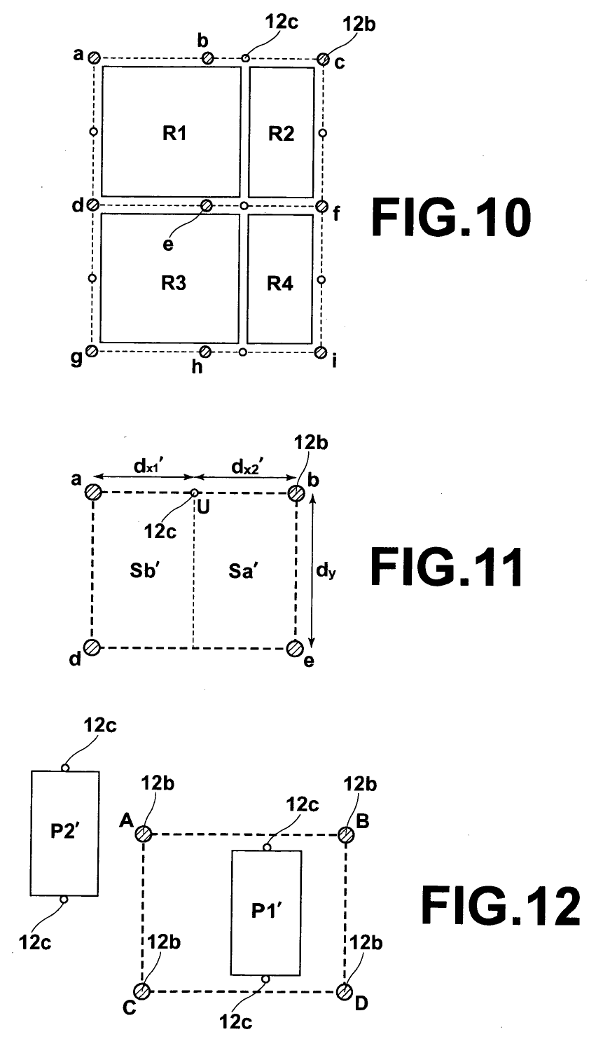

The manner of setting the reference-mark-position information and the recording-position information is not limited to the manner illustrated in FIG. 6. For example, it is possible to set the reference-mark-position information and the recording-position information arranged in relationships as illustrated in FIG. 9 or 10, which are diagrams schematically illustrating second and third exemplary arrangements of reference marks and wiring patterns on a substrate before deformation, and arrangement-determination positions for the wiring patterns before correction. It is preferable that at least two wiring patterns be arranged in the largest area defined by the reference marks (i.e., the area defined by the outermost reference marks).

In the case where the reference-mark-position information and the recording-position information are set as illustrated in FIG. 9, it is preferable that the recording-position information for the wiring patterns Q1 to Q4 be corrected by using reference-mark-position information and detected-mark information for the reference marks a, b, c, and d surrounding the wiring patterns Q1 to Q4, the recording-position information for the wiring patterns Q5 to Q8 be corrected by using reference-mark-position information and detected-mark information for the reference marks b, c, e, and f surrounding the wiring patterns Q5 to Q8, the recording-position information for the wiring patterns Q9 to Q12 be corrected by using reference-mark-position information and detected-mark information for the reference marks d, e, g, and h surrounding the wiring patterns Q9 to Q12, and the recording-position information for the wiring patterns Q13 to Q16 be corrected by using reference-mark-position information and detected-mark information for the reference marks e, f, h, and i surrounding the wiring patterns Q13 to Q16.

In the case where the reference-mark-position information and the recording-position information are set as illustrated in FIG. 10, it is preferable that the recording-position information for the wiring pattern R1 be corrected by using reference-mark-position information and detected-mark information for the reference marks a, b, d, and e, the recording-position information for the wiring pattern R2 be corrected by using reference-mark-position information and detected-mark information for the reference marks b, c, e, and f, the recording-position information for the wiring pattern R3 be corrected by using reference-mark-position information and detected-mark information for the reference marks d, e, g, and h, and the recording-position information for the wiring pattern R4 be corrected by using reference-mark-position information and detected-mark information for the reference marks e, f, h, and i.

Even in the case where the reference-mark-position information and the recording-position information are set as illustrated in FIG. 9 or 10, the recording-position information can be corrected by using the methods explained before.

In particular, an arrangement-determination position located on a line connecting two reference marks can be corrected as follows. For example, in the case where the arrangement-determination position U as illustrated in FIG. 11 is corrected, the corrected coordinate values (x_{U}, y_{U}) of the arrangement-determination position U (as corrected recording-position information for the arrangement-determination position U) can be calculated by obtaining the areas Sa′ and Sb′ of the two divided regions on the basis of the preset coordinate values of the arrangement-determination position U and the coordinate values of the four reference marks a, b, d, and e surrounding the arrangement-determination position U, and substituting the detected coordinate values (xa, ya) and (xb, yb) of the reference marks a and b, into the equation,

$$( \begin{matrix}{x}_{U} \\ {y}_{U}\end{matrix} ) = ( {Sa}^{′} ( \begin{matrix}{x}_{a} \\ {y}_{a}\end{matrix} ) + {Sb}^{′} ( \begin{matrix}{x}_{b} \\ {y}_{b}\end{matrix} ) ) / ( {Sa}^{′} + {Sb}^{′} ) , \qquad ( 2 )$$

where Sa′=dₓ₂′×d_{y}, Sb′=dₓ₁′×d_{y}, dₓ₂′ is the distance between the reference mark a and the arrangement-determination position U, and dₓ₁′ is the distance between the reference mark b and the arrangement-determination position U. The above equation (2) can be rewritten as the equation,

$$( \begin{matrix}{x}_{U} \\ {y}_{U}\end{matrix} ) = ( {d}_{{x2}^{′}} ( \begin{matrix}{x}_{a} \\ {y}_{a}\end{matrix} ) + {d}_{{x1}^{′}} ( \begin{matrix}{x}_{b} \\ {y}_{b}\end{matrix} ) ) / ( {d}_{{x2}^{′}} + {d}_{{x1}^{′}} ) . \qquad ( 3 )$$

That is, the corrected coordinate values (x_{U}, y_{U}) of the arrangement-determination position U as the corrected recording-position information for the arrangement-determination position U can be calculated by using the equation (3) without obtaining the areas Sa′ and Sb′ of the two divided regions.

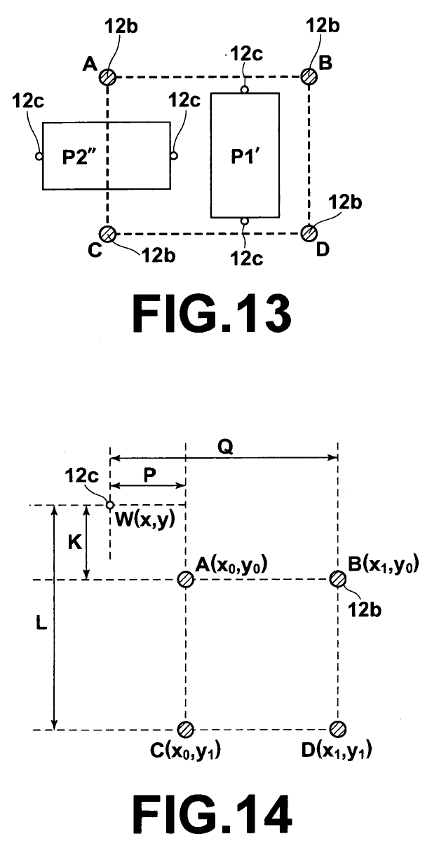

In the above explanations, methods for correcting the arrangement-determination positions 12c for the wiring patterns (as the recording-position information for the wiring patterns) located within regions surrounded by a plurality of predetermined reference marks are indicated. However, for example, it is also possible to correct the recording-position information for the wiring pattern P2′ located outside the region surrounded by the reference marks A, B, C, and D as indicated by the dashed lines in FIG. 12, as well as the recording-position information for the wiring pattern P1′ located within the region surrounded by the reference marks A, B, C, and D, on the basis of the reference-mark-position information and the detected-mark information for the reference marks A, B, C, and D. Further, it is possible to correct the recording-position information for the wiring pattern P2″ partially located inside the region surrounded by the reference marks A, B, C, and D as indicated in FIG. 13, as well as the recording-position information for the wiring pattern P1′ located within the region surrounded by the reference marks A, B, C, and D, on the basis of the reference-mark-position information and the detected-mark information for the reference marks A, B, C, and D. Furthermore, it is possible to correct the recording-position information for at least two wiring patterns located outside the region surrounded by the reference marks A, B, C, and D, on the basis of the reference-mark-position information and the detected-mark information for the reference marks A, B, C, and D.

A method for correcting the arrangement-determination positions 12c for wiring patterns (as the recording-position information for wiring patterns) located outside a region surrounded by a plurality of predetermined reference marks is indicated below. FIG. 14 is a diagram presented for explaining a third exemplary method for correcting the recording-position information (the arrangement-determination positions). In the case where a arrangement-determination position 12c is located outside a region surrounded by the reference marks A, B, C, and D as illustrated in FIG. 14, the corrected coordinate values (x_{W}′, y_{W}′) of the arrangement-determination position W (as corrected recording-position information) can be calculated by substituting the detected coordinate values (x₀′, y₀′), (x₁′, y₀′), (x₀′, y₁′), and (x₁′, y₁′) of the four reference marks A, B, C, and D into the following equations (4) and (5).
x_{W}′=(x₀′×Q−P×x₁′)/(Q−P) (4)
Y_{W}′=(y₀′×L−K×y₁′)/(L−K) (5)
In the equations (4) and (5), P=x₀−x, Q=x₁−x, K=y−y₀, L=y−y₁, and the coordinate values of the arrangement-determination position W before correction and the four reference marks A, B, C, and D on an undeformed substrate are (x, y), (x₀, y₀), (x₁, y₀), (x₀, y₁), and (x₁, y₁), respectively, as illustrated in FIG. 14.

The methods for correcting the arrangement-determination positions 12c or recording positions indicated by the recording-position information are not limited to the methods explained above, and the arrangement-determination positions 12c as the recording-position information can be corrected by using any known calculation method in which the difference of the positional relationship between the detected positions of the reference marks 12a and each of the arrangement-determination positions 12c (or recording positions) after correction, from the positional relationships between the predetermined positions 12b of the reference marks 12a and the arrangement-determination position 12c (or recording positions) before correction is small.

Further, it is possible to configure the exposure system in advance so as to use a specific portion of the reference marks in correction of each of the arrangement-determination positions 12c (or recording positions), or to automatically select a specific portion of the reference marks for use in correction of each of the arrangement-determination positions 12c (or recording positions), in accordance with a predetermined condition when the arrangement-determination position 12c (or recording position) is determined.

For example, it is possible to configure the exposure system so as to choose a portion of the reference marks which defines the minimum region surrounding each group of arrangement-determination positions (or recording positions) when the group of arrangement-determination positions (or recording positions) are set. Alternatively, it is possible to calculate the distance from each of the arrangement-determination positions 12c to the positions 12b of the reference marks 12a, and choose a predetermined number of ones of the reference marks which are relatively near to the arrangement-determination position, for use in correction of the arrangement-determination position. Further, it is also possible to divide in advance the entire region on the substrate into a plurality of divided regions by lines connecting the positions 12b of the reference marks 12a, and correct one or more of the arrangement-determination positions 12c (or recording positions) arranged in each divided region, by using ones of the positions 12b of the reference marks 12a corresponding to the divided region.

As explained above, in the exposure system 10 according to the present embodiment, a plurality of reference marks 12a, which are arranged in advance at the positions 12b on a substrate 12 indicated by the reference-mark-position information (which is preset), are detected so that detected-mark information indicating the positions of the detected reference marks and being common to the wiring patterns is obtained. Then, at least one arrangement-determination position 12c (or at least one recording position) being prepared for each of at least two wiring patterns and indicating the arrangement of the wiring pattern is individually corrected according to the deviations of the positions indicated by the detected-mark information from the positions 12b indicated by the reference-mark-position information, and the wiring patterns are recorded on the substrate 12 so as to be arranged on the basis of the corrected arrangement-determination positions 12c (or corrected recording positions). Therefore, in the case where a great number of small-sized wiring patterns are exposed on a large substrate, it is possible to achieve highly precise position alignment of the wiring patterns without influence of deformation of the substrate 12. In addition, reference marks are not provided for each of wiring patterns, and the arrangement in which each of the wiring patterns is to be recorded is indicated by at least one of the arrangement-determination positions 12c (or corrected recording positions) determined for the wiring pattern. Therefore, it is unnecessary to prepare substrates having different reference marks according to the sizes, shapes, and arrangements of the wiring patterns. Thus, the manufacturing efficiency can be increased.

The exposure system 10 according to the present embodiment can expose an image pattern constituted by a plurality of wiring patterns, on a great number of substrates. However, in such a case, it is necessary to correct the arrangement-determination positions (or recording positions) for each substrate 12. At this time, if corrected image data is obtained by correcting the vector data (before being converted into the raster data) by using the corrected recording-position information, it is necessary to convert the corrected vector data into raster data every time the arrangement-determination positions 12c (or recording positions) are corrected for each substrate. Nevertheless, since the exposure system 10 obtains the corrected image data by correcting the raster data by use of the corrected arrangement-determination positions 12c (or recording positions), the conversion of vector data to raster data is required to be performed only once, i.e., the number of conversion operations to raster data can be reduced, and the reduction in the number of conversion operations increases the processing speed.

However, even in the system in which vector data is corrected by using the arrangement-determination positions 12c (or recording positions), and then the corrected vector data is converted into raster data, the manufacturing efficiency is increased by the relaxation of the constraints imposed on the number and positions of the reference marks 12a. Therefore, the present invention can also be applied to such a system.

The image-recording method and the image-recording apparatus according to the present invention can also be used for ink-jet printing (i.e., in an ink-jet printer) as well as the exposure system explained above. That is, the manner of alignment according to the present embodiment can also be used in devices in which images are recorded with dots produced by spewed out droplets.

The exposure system 10 according to the present embodiment can record different types of images on a substrate. Since the exposure system 10 allocates the images by using the recording-position information, and the images can be allocated with respect to the positions of the reference marks 12a with high degree of freedom, it is easy to allocate the images of different types. In addition, since the degree of freedom of the image allocation is high, images can be allocated so that the surface of the substrate is efficiently used. That is, it is possible to allocate an image to and record the image in a region of a substrate which cannot be used in the case where the entire region is divided on the basis of the positions of the reference marks 12a (e.g., the image can be recorded in a near-edge region of the substrate).

Further, images can be recorded in such a manner that only one image indicated by the recording-position information is allocated in each of the divided regions defined by division on the basis of the positions of the reference marks 12a, where the size of the image is smaller than the divided region. Since the position at which each image is allocated can be adjusted in this case, it is possible to realize a desired pattern arrangement.

Furthermore, in some cases where alignment is measured while a substrate is moved along a direction in the exposure system 10 according to the embodiment, the positions at which the reference marks 12a are arranged are limited. However, even in such cases, images can be allocated on the basis of the recording-position information, and therefore it is also possible to realize a desired pattern arrangement. In other words, according to the present embodiment, it is possible to reduce the constraint of the desired pattern arrangement which is imposed on determination of the positions of the reference marks 12a.

Moreover, according to the present embodiment, it is possible to individually set positional relationships between the positions 12b of the reference marks 12a and the arrangement-determination positions 12c (or recording positions) for images on an image-by-image basis. In other words, it is possible to set different positional relationships for different images, although it is possible to set an identical or similar positional relationship for some different images. Therefore, the constraints imposed on the arrangement of the reference marks 12a can be further reduced.

In addition, all of the contents of the Japanese patent applications Nos. 2004-287320, 2005-069332, and 2005-247166 are incorporated into this specification by reference.

What is claimed is:

1. An image-recording method for recording at least two images at desired positions on an image-recordable object, comprising the steps of:
(a) detecting positions of a plurality of reference marks arranged on said image-recordable object and common to said at least two images;
(b) individually correcting at least one recording position for each of said at least two images on the basis of said positions of the plurality of reference marks, where the at least one recording position has a positional relationship with the plurality of reference marks; and
(c) recording said at least two images on said image-recordable object in such a manner that each of the at least two images is arranged in accordance with said at least one recording position corrected.

2. An image-recording method according to claim 1, wherein in said step (b), said recording position is individually corrected on the basis of deviations of said positions of the plurality of reference marks detected, from predetermined positions of the reference marks.

3. An image-recording method according to claim 1, wherein in said step (b), said recording position is corrected on the basis of said positions of the plurality of reference marks detected and said positional relationship.

4. An image-recording method according to claim 3, wherein said positional relationship is given as a function.

5. An image-recording method according to claim 1, wherein said step (c) comprises the substeps of,
(c1) generating corrected image data by correcting image data representing an entire image which includes said at least two images and is to be recorded in a predetermined region on said image-recordable object, on the basis of said recording position corrected, and
(c2) recording said entire image including said at least two images on said predetermined region in accordance with said corrected image data.

6. An image-recording method for recording at least two images at desired positions on an image-recordable object, comprising the steps of:
(a) detecting positions of a plurality of reference marks arranged on said image-recordable object;
(b) individually correcting at least one recording position for each of said at least two images on the basis of said positions of the plurality of reference marks, where the at least one recording position is determined so that the at least two images are located in a region determined by the plurality of reference marks; and
(c) recording said at least two images on said image-recordable object in such a manner that each of the at least two images is arranged in accordance with said at least one recording position corrected.

7. An image-recording method according to claim 6, wherein in said step (b), said recording position is individually corrected on the basis of deviations of said positions of the plurality of reference marks detected, from predetermined positions of the reference marks.

8. An image-recording method according to claim 6, wherein in said step (b), said recording position is individually corrected on the basis of said positions of the plurality of reference marks detected and a positional relationship between the recording position and the plurality of reference marks.

9. An image-recording method according to claim 8, wherein said positional relationship is given as a function.

10. An image-recording method according to claim 6, wherein said step (c) comprises the substeps of,
(c1) generating corrected image data by correcting image data representing an entire image which includes said at least two images and is to be recorded in a predetermined region on said image-recordable object, on the basis of said recording position corrected in said step (b), and
(c2) recording said entire image including said at least two images on said predetermined region in accordance with said corrected image data.

11. An image-recording method for recording at least two images at desired positions on an image-recordable object, comprising the steps of:
(a) detecting positions of a plurality of reference marks arranged on said image-recordable object;
(b) individually correcting at least one recording position for each of said at least two images on the basis of said positions of the plurality of reference marks, and a positional relationship between the at least one recording position and the plurality of reference marks, the positional relationship being specific to the at least one recording position; and
(c) recording said at least two images on said image-recordable object in such a manner that each of the at least two images is arranged in accordance with said recording position corrected.

12. An image-recording method according to claim 11, wherein said positional relationship is given as a function.

13. An image-recording method for recording at least one image at desired position on an image-recordable object, comprising the steps of:
(a) detecting positions of a plurality of reference marks arranged on said image-recordable object;
(b) correcting at least two recording positions for said at least one image on the basis of said positions of the plurality of reference marks, where each of the at least two recording positions has a positional relationship with the plurality of reference marks; and
(c) recording said at least one image on said image-recordable object so that an arrangement, including at least one of inclination, expansion, contraction and size, of the at least one image is corrected in accordance with the at least two recording positions corrected.

14. An image-recording method according to claim 13, wherein in said step (b), each of said at least two recording positions is corrected on the basis of deviations of said positions of the plurality of reference marks detected, from predetermined positions of the reference marks.

15. An image-recording method according to claim 13, wherein in said step (b), each of said at least two recording positions is corrected on the basis of said positions of the plurality of reference marks detected and said positional relationship.

16. An image-recording method according to claim 13, wherein said positional relationship with the plurality of reference marks is set for each of said at least one image.

17. An image-recording method according to claim 15, wherein said positional relationship is given as a function.

18. An image-recording method according to claim 13, wherein said step (c) comprises the substeps of,
(c1) generating corrected image data by correcting image data representing an entire image which includes said at least one image and is to be recorded in a predetermined region on said image-recordable object, on the basis of said at least two recording positions corrected in said step (b), and
(c2) recording said entire image including said at least one image on said predetermined region in accordance with said corrected image data.

19. An image-recording apparatus for recording at least two images at desired positions on an image-recordable object, comprising:
a detection unit which detects positions of a plurality of reference marks arranged in advance on said image-recordable object and common to said at least two images;
a correction unit which individually corrects recording positions of said at least two images on the basis of said positions of the plurality of reference marks detected by said detection unit, where each of the recording positions has a positional relationship with the plurality of reference marks; and
a recording unit which records said at least two images on said image-recordable object in such a manner that the at least two images are respectively arranged in accordance with said recording positions corrected by said correction unit.

20. An image-recording apparatus according to claim 19, wherein said recording positions are individually corrected by said correction unit on the basis of deviations of said positions of the plurality of reference marks detected by said detection unit, from predetermined positions of the reference marks.

21. An image-recording apparatus according to claim 19, wherein said each of said recording positions is individually corrected by said correction unit on the basis of said positions of the plurality of reference marks detected by said detection unit and said positional relationship.

22. An image-recording apparatus according to claim 21, wherein said positional relationship is expressed as a function.

23. An image-recording apparatus according to claim 19, further comprising an image-data correction unit which generates corrected image data by correcting image data representing an entire image to be recorded in a predetermined region on said image-recordable object, where the entire image includes said at least two images, and said recording unit records said at least two images in accordance with said corrected image data.

24. An image-recording apparatus for recording at least two images at desired positions on an image-recordable object, comprising:
a detection unit which detects positions of a plurality of reference marks arranged in advance on said image-recordable object;
a correction unit which individually corrects recording positions of said at least two images on the basis of said positions of the plurality of reference marks detected by said detection unit, where the recording positions are determined so that the at least two images are located in a region determined by the plurality of reference marks; and
a recording unit which records said at least two images on said image-recordable object in such a manner that the at least two images are respectively arranged in accordance with said recording positions corrected by said correction unit.

25. An image-recording apparatus according to claim 24, wherein said recording positions are individually corrected by said correction unit on the basis of deviations of said positions of the plurality of reference marks detected by said detection unit, from predetermined positions of the reference marks.

26. An image-recording apparatus according to claim 24, wherein each of said recording positions is corrected by said correction unit on the basis of said positions of the plurality of reference marks detected by said detection unit and a positional relationship between said each of the recording positions and the plurality of reference marks.

27. An image-recording apparatus according to claim 26, wherein said positional relationship is expressed as a function.

28. An image-recording apparatus according to claim 24, further comprising an image-data correction unit which generates corrected image data by correcting image data representing an entire image to be recorded in a predetermined region on said image-recordable object, where the entire image includes said at least two images, and said recording unit records said at least two images in accordance with said corrected image data.

29. An image-recording apparatus for recording at least two images at desired positions on an image-recordable object, comprising:
a detection unit which detects positions of a plurality of reference marks arranged in advance on said image-recordable object;
a correction unit which corrects each of recording positions of said at least two images on the basis of said positions of the plurality of reference marks detected by said detection unit, and a positional relationship between said each of the recording positions and the plurality of reference marks; and
a recording unit which records said at least two images on said image-recordable object in such a manner that the at least two images are respectively arranged in accordance with said recording positions corrected by said correction unit.

30. An image-recording apparatus for recording at least one image at at least one desired position on an image-recordable object, comprising:
a detection unit which detects positions of a plurality of reference marks arranged in advance on said image-recordable object;
a correction unit which corrects at least two recording positions for said at least one image on the basis of said positions of the plurality of reference marks detected by said detection unit, where each of the at least two recording positions has a positional relationship with the plurality of reference marks; and
a recording unit which records said at least one image on said image-recordable object so that arrangement, including at least one of inclination, expansion, contraction and size, of each of the at least one image is corrected in accordance with the at least two recording positions corrected by said correction unit.

31. An image-recording apparatus according to claim 30, wherein each of said at least two recording positions is corrected by said correction unit on the basis of deviations of said positions of the plurality of reference marks detected by said detection unit, from predetermined positions of the reference marks.

32. An image-recording apparatus according to claim 30, wherein said each of said at least two recording positions is corrected by said correction unit on the basis of said positions of the plurality of reference marks detected by said detection unit and said positional relationship.

33. An image-recording apparatus according to claim 30, wherein said positional relationship with the plurality of reference marks is set for each of said at least one image.

34. An image-recording apparatus according to claim 32, wherein said positional relationship is expressed as a function.

35. An image-recording apparatus according to claim 30, further comprising an image-data correction unit which generates corrected image data by correcting image data representing an entire image to be recorded in a predetermined region on said image-recordable object, where the entire image includes said at least one image, and said recording unit records said at least one image in accordance with said corrected image data.

36. An image-recording method for recording at least one image at at least one desired position on an image-recordable object, comprising the steps of:
(a) detecting positions of a plurality of reference marks which are arranged in advance on said image-recordable object;
(b) correcting at least two arrangement-determination positions for each of said at least one image on the basis of said positions of the plurality of reference marks detected in said step (a), where each of the at least two arrangement-determination positions has a positional relationship with the plurality of reference marks, and said at least two arrangement-determination positions for each of the at least one image is adapted to determine an arrangement, including at least one of inclination, expansion, contraction and size, of said each of the at least one image; and
(c) recording said at least one image on said image-recordable object in said arrangement determined by said at least two arrangement-determination positions corrected in said step (b).

37. An image-recording apparatus for recording at least one image at at least one desired position on an image-recordable object, comprising:
a detection unit which detects positions of a plurality of reference marks arranged in advance on said image-recordable object;
a correction unit which corrects at least two arrangement-determination positions for each of said at least one image on the basis of said positions of the plurality of reference marks detected by said detection unit, where said each of the at least two arrangement-determination positions has a positional relationship with the plurality of reference marks, and at least two arrangement-determination positions for each of the at least one image is adapted to determine an arrangement, including at least one of inclination, expansion, contraction and size, of said each of the at least one image; and
a recording unit which records said at least one image on said image-recordable object in such a manner that the at least two images are respectively arranged in accordance with said at least two arrangement-determination positions corrected by said correction unit.
